(19) United States
(12) Patent Application Publication
(10) Pub. No.: US 2006/0099845 A1
(43) Pub. Date: May 11, 2006

(54) CONNECTOR SUPPORT FOR DIRECT CONNECTION TO A PRINTED CIRCUIT BOARD

(75) Inventor: Josep Maria Roset Rubio, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/904,372

(22) Filed: Nov. 7, 2004

(51) Int. Cl. H01R 13/62

(52) U.S. Cl. 439/372

(57) ABSTRACT

Especially designed for printed circuit boards associated to power circuits, combined with electronic circuits, this invention consists of a body (1) shaped like a prismatic cup, provided with side tabs (4) with holes (5) for their fixing by screwing to the printed circuit board, a body (1) which, at the bottom (2), incorporates power terminals (6) projecting both outwardly and inwardly, for being connected to the printed circuit board and for receiving the complementary connector, such that the latter is not directly inserted on the board but rather the insertion thereof is carried out on the intermediate support. A lower lug (7) with asymmetric positioning assures the polarization of the support in the assembly thereof on the printed circuit board, whereas an inner and also symmetric partition (8) in turn assures the correct polarization of the connector in its assembly in the housing of the support.

### OBJECT OF THE INVENTION

The present invention refers to a support which has been specially designed as a bridge between a connector and a printed circuit board, such that it is said support that which is originally connected and fixed to the printed circuit board and on which the subsequent coupling and decoupling operations, i.e. connection and disconnection, of the connector are carried out.

The invention is especially suitable for being used in power circuits and the object of the invention is to eliminate the risk of damages occurring in the printed circuit board when inserting the power terminals of the electric component.

The invention is especially applicable within the automotive field, in which power circuits are combined with electronic circuits, such as signalling circuits, for example.

### BACKGROUND OF THE INVENTION

The working voltages used in the automotive field, generally 12 volts, make for high intensities in power circuits, which oblige the use of strong and bulky terminals for the electric components of a circuit.

This implies that currently, and within the aforementioned field, independent or separated printed circuit boards are used, some for the electronic circuits and others for the power circuits.

On the other hand, the sturdiness of power terminals makes it so that when carrying out the insertion thereof in the printed circuit boards, it is possible for damages to occur in the boards.

On the other hand, and in the field of practical application of the invention, the automotive field, there are usually problems with space, making it necessary to assemble both the electronic components as well as the power components on the same board, which worsens the drawbacks set forth above. Different connectors with polarization means can be found in the state of the art, but none of them solve the problems above mentioned. Some of these connectors are described in US-B1-6302744, U.S. Pat. No. 6,080,022, U.S. Pat. No. 5,624,279, and U.S. Pat. No. 5,370,557, but none of them refers to a connector that permits the use of only printed circuit board in junction boxes, combining power and electronics applications.

### DESCRIPTION OF THE INVENTION

The support proposed by the invention solves in a fully satisfactorily manner the drawbacks set forth above, allowing for the assembly of both the electronic components and the power components on a single board, such that the assembly of the latter is not carried out by directly inserting the power terminals in the printed circuit board, but rather by inserting them in the support, previously fixed to said board.

Said support is materialized in a body shaped as a prismatic-rectangular cup, at the bottom of which power terminals are arranged which project both inwardly and outwardly therefrom, the outer terminals obviously being intended for their connection to the printed circuit board, whereas the inner ones are in turn intended for receiving the connector at hand.

Said body has a pair of opposing and perforated side tabs for the fixing thereof to the printed circuit board by means of riveting, assuring a perfect immobilization between both elements in which no connection terminals are involved.

According to another feature of the invention, the body of the support has polarization means on the outer side of its base which determine a single possibility for assembly on the printed circuit board, preferably materialized in an asymmetric positioning lug determining, in combination with a hole for printed circuit boards, and in collaboration with the holes themselves for the riveting of the support, that the latter can only be coupled to the board in that position in which polarization of the terminals of the support is correct.

Said body is complementarily polarized internally, specifically with the collaboration of side and internal partitions, situated in correspondence with one of its side walls which, in combination with complementary housings for the connector for which it is intended, in turn determine a single positioning for the access of the latter to the interior of the support, the one in turn corresponding to the correct polarization.

In the event that supports with different polarizations are required for different practical applications, the special configuration of the previously mentioned polarization means allows obtaining two different parts in the same mold by means of slight changes therein.

### DESCRIPTION OF THE DRAWINGS

To complement the description being made and for the purpose of better understanding the features of the invention, according to a practical embodiment example thereof, a set of drawings is attached as an integral part of said description, in which drawings the following has been shown with an illustrative and non-limiting character:

FIG. 1 shows an upper side perspective view of a connector support for the direct connection to a printed circuit board carried out according to the object of the present invention.

FIG. 2 shows another perspective view of the same support, opposite to the one of the previous figure.

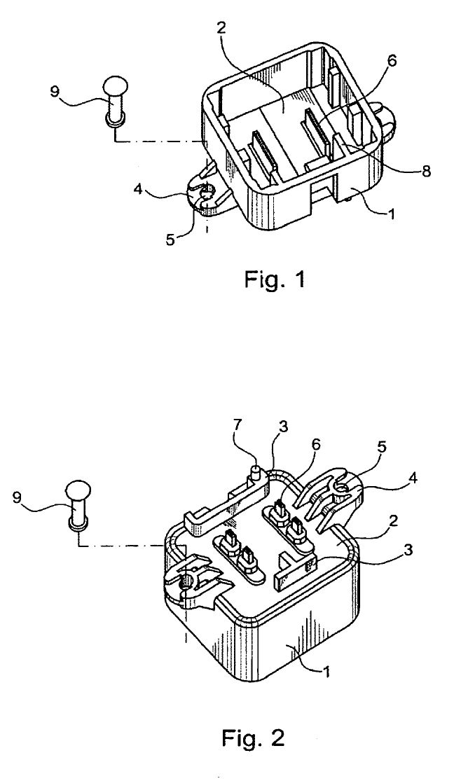

### PREFERRED EMBODIMENT OF THE INVENTION

In view of the figures mentioned, it can be seen how the support proposed by the invention is constituted of a body (1) forming a prismatic-rectangular cup, suitable in shape and size for receiving therein the corresponding power connector, not shown in the drawings, a body (1) which, at its base (2), externally incorporates a plurality of partitions (3) determining, through their lower and free edges, the support areas for the support on the printed circuit board, not shown in the drawings either, and furthermore having a pair of side tabs (4) with holes (5) duly facing complementary holes of said printed circuit board, allowing for a solid fixing of the support to the board by means of riveting or by any other means.

The terminals (6) intended for connecting the connector with the printed circuit board are inserted at the base (2) of the body, such that said terminals (6) project, forming coupling and connection pins (6′) to the printed circuit board, and in the upper portion, male terminals (6) for receiving the complementary female terminals of the connector, said terminals (6-6′) being duly joined to the support (1) in the injection molding phase for obtainment thereof.

As a complement of the described structure, the body (1) incorporates a lug (7) on the outer side of its base (2), projecting, for example, from one of the partitions (3) and in an asymmetric position, such that this lug (7), in combination with a complementary hole operatively arranged on the printed circuit board, determines that there is only a single position for assembling the support on the board, that position in which the polarization of the terminals (6-6′) is correct.

For its part, a partition (8) is arranged inside the body (1) and on one of its side walls, perpendicular to its bottom, also in an asymmetric position, which in combination with a slit of the connector, also obliges a predetermined relative and single positioning of both elements, i.e. between support and connector, in turn maintaining the correct polarization.

Thus, at the moment of assembly, the body (1) of the support is fixed by means of riveting of the printed circuit board in the correct position defined by the lug (7), its power terminals (6′) being connected to the power circuit of the printed circuit board, and under these conditions, the complementary connector can be connected and disconnected from the support as many times as needed without the connections of the printed circuit board undergoing any damage during this operation, also assuring that the assembly of the connector on the support is the correct one, from the polarization point of view, insomuch as there is only one assembly possibility.

1. A connector support for the direct immoveable connection of a connector to a printed circuit board suitable for use on printed circuit boards combining power circuits with electronic circuits providing assembly/disassembly of said connector from said connector support, said connector support being immovably fixed to said printed circuit board, and in which the connector must be detachably associated to the printed circuit board comprising:
a body (1) having a substantially prismatic-rectangular cup shape for receiving therein the corresponding connector, said body (1) also provided with a pair of tabs (4) having holes (5) for fixedly attaching said connector support to said printed circuit board using permanent fasteners; and
connectors (6-6′) being arranged on the base (2) of said body (1), said connectors (6-6′) emerging both towards the outer side of the base for their connection to the printed circuit board, and towards the inner side thereof for receiving the complementary connector.

2. A connector support for the direct immoveable connection of a connector to a printed circuit board according to claim 1, wherein said body (1) incorporates a lug (7), on the outer side of said base (2) in an asymmetric position, complementary to a hole existing on said printed circuit board, thereby determining a single relative position for assembling said connector support on said circuit board, corresponding to the correct polarization of said terminals (6) of said connector support.

3. A connector support for the direct immoveable connection of a connector to a printed circuit board according to claim 1, body (1) incorporates at least one partition (8) on the inner side of one of its side walls in an asymmetric position, determining a single position for assembling said connector inside said connector support; thereby assuring correct polarization for said connector.

4. A connector support for the direct immoveable connection of a connector to a printed circuit board according to claim 2, wherein said body (1) incorporates at least one partition (8) on the inner side of one of its side walls in an asymmetric position, determining a single position for assembling said connector inside said connector support; thereby assuring correct polarization for said connector.

5. A connector support for the direct connection to a printed circuit board according to claim 1, characterized in that said permanent fasteners are rivets.
